(19) United States
(12) Patent Application Publication
(10) Pub. No.: US 2011/0034088 A1
(43) Pub. Date: Feb. 10, 2011

(54) ELECTRICAL CONNECTOR HAING HIGH DENSITY CONTACTS FOR MINIATURIZATION

(75) Inventors: YU-HUA MAO, Kunshan (CN); ZHI-HONG FANG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/758,716

(22) Filed: Apr. 12, 2010

(30) Foreign Application Priority Data
Aug. 10, 2009 (CN) 200910305427.1

(51) Int. Cl. H01R 13/502

(52) U.S. Cl. 439/701

(57) ABSTRACT

An electrical connector includes an insulative housing (1) with a rear portion (11) and a front portion (12) along a first direction (A), a spacer (4) assembled on the rear portion (11) which has a plurality of first wedged positioning sections (42, 43) in an inner side thereof and arranged along a second direction (B) and a plurality of contacts (2) received in the insulative housing and comprising a soldering portion (203) extending out of the insulative housing. The spacer (4) includes a plurality of positioning grooves (45) in an external side thereof for receiving and positioning the soldering portions (203c) of one part contacts (23) located at an upper side of the front portion (12). The soldering portions (203a, 203b) of the other contacts (21a, 21b) are sandwiched between the spacer (4) and the rear portion (11) thereby forms a waved configuration.

This application is related to so and so U.S. patent application Ser. No. 12/755,383, filed Apr. 6, 2010, entitled “LOW PROFILE CONNECTOR WITH COMBO SOLDER TAILS”, and which is assigned to the common assignee, and is incorporated herewith for reference.

### BACKGROUND OF THE INVENTION

1. Field of the Invention

The present invention relates to an electrical connector having a plurality of high density contacts for miniaturization.

2. Description of the Related Art

U.S. Pat. No. 7,537,465 issued to Mao et. al on May 26, 2009,discloses an electrical connector including an insulative housing, a plurality of contact units arranged in the insulative housing along a horizontal direction, a shielding shell covering on the insulative housing and a spacer assembled with the insulative housing. The insulating housing defines a front end portion and a rear end portion having a first wedged positioning section. The contact includes a tail portion extending out of the rear end portion of the insulative housing. The spacer has a second wedged positioning section corresponding to and engaging with the rear end portion of the insulative housing thereby forming a positioning device for sandwiching the tail portion of the contact therein. So the contacts are retained between the rear end portion of the insulating housing and the spacer.

With development of electronics technology, the numbers of the contacts need to be increased and then the size of the spacer in the horizontal direction would be changed to become more bigger than before if the contacts are arranged on the spacer in original pitch. On the contrary, the interval between the two adjacent contacts is required to be smaller and smaller if the original pitch is decreased to keep the original size of electrical connector, so it would generate electronic magnetic interference between adjacent contacts.

Therefore, an improved electrical connector is desired to overcome the disadvantages of the related arts.

### SUMMARY OF THE INVENTION

An object of the present invention is to provide a miniaturize electrical connector having a plurality of high density contacts, but being able to transmit a high quality signal.

In order to achieve above-mentioned object, an electrical connector in accordance with a preferred embodiment of the present invention includes an insulative housing with a rear portion and a front portion along a first direction, a spacer assembled on the rear portion which has a plurality of first wedged positioning sections in an inner side thereof and arranged along a second direction and a plurality of contacts received in the insulative housing and comprising a soldering portion extending out of the insulative housing. The spacer includes a plurality of positioning grooves in an external side thereof for receiving and positioning the soldering portions of one part contacts located at an upper side of the front portion. The soldering portions of the other contacts are sandwiched between the spacer and the rear portion thereby forms a waved configuration.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the preferred embodiment of the present invention;

FIG. 2 is an exploded perspective view of the electrical connector of FIG. 1;

FIG. 3 is another perspective view of the electrical connector of FIG. 1 viewed from a front view;

FIG. 4 is a cross-section view of the electrical connector taken along line 4-4 of FIG. 1;

FIG. 5 is a cross-section view of the electrical connector taken along line 5-5 of FIG. 1;

FIG. 6 is a bottom plan view of the electrical connector of FIG. 1;

FIG. 7 is a partial enlarged view of the electrical connector of FIG. 6;

FIG. 8 is a perspective view of a spacer and a plurality of contacts assembled with the spacer of FIG. 2; and

FIG. 9 is a partial enlarged view of the electrical connector of FIG. 8.

### DETAILED DESCRIPTION OF THE INVENTION

Reference will now be made to the drawing figures to describe the preferred embodiment of the present invention in detail.

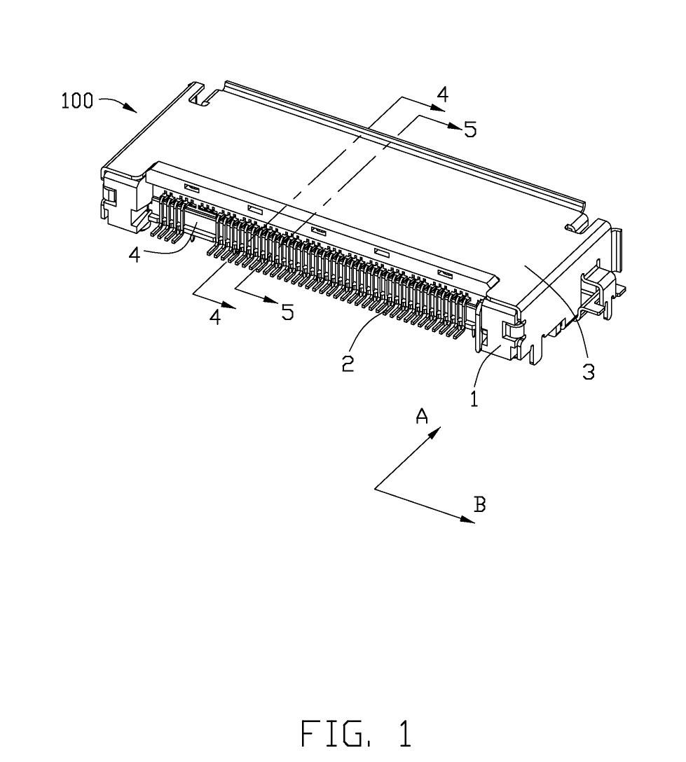

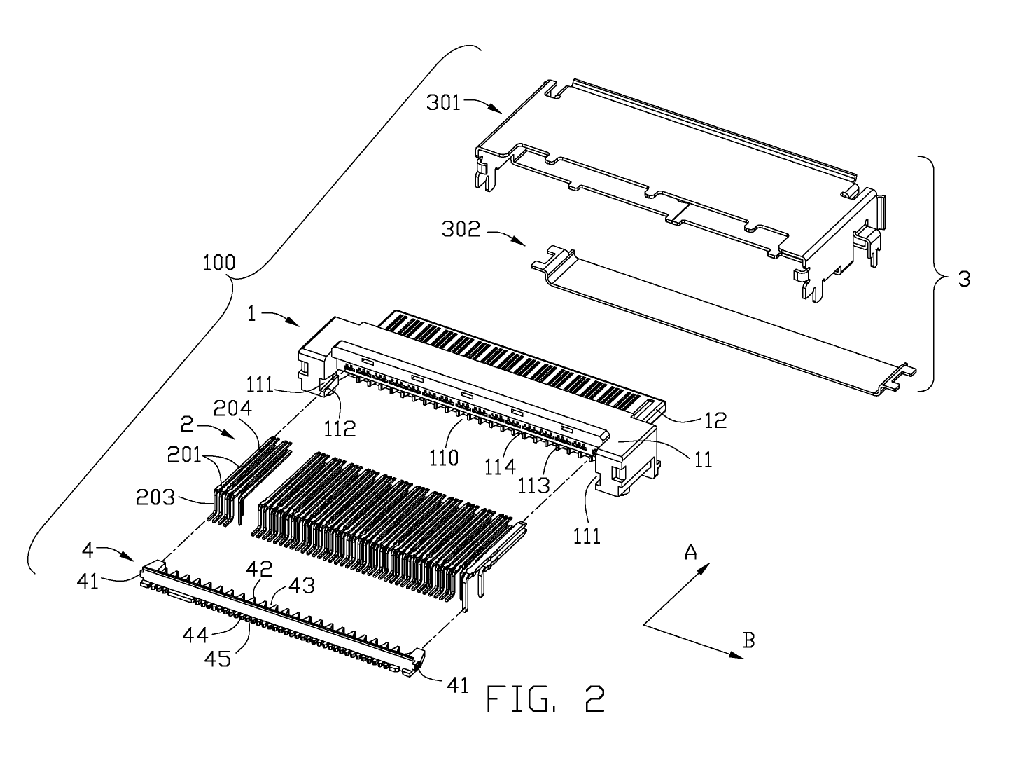

Referring to FIGS. 1 and 2, an electrical connector 100 in accordance with the present invention includes an insulative housing 1 with a rear portion 11 regarded as a base portion and a front portion 12 regarded as an engaging portion along a first direction, i.e. direction A, a plurality of contacts 2 received in the insulative housing and arranged along a second direction, i.e. direction B, a metallic shell 3 and a spacer 4 assembled on the base portion 11 of the insulative housing 1. The metallic shell 3 includes a top shell 301 and a bottom shell 302 thereby surrounding and covering on the housing 10 for providing a perfect shielding with a simple structure.

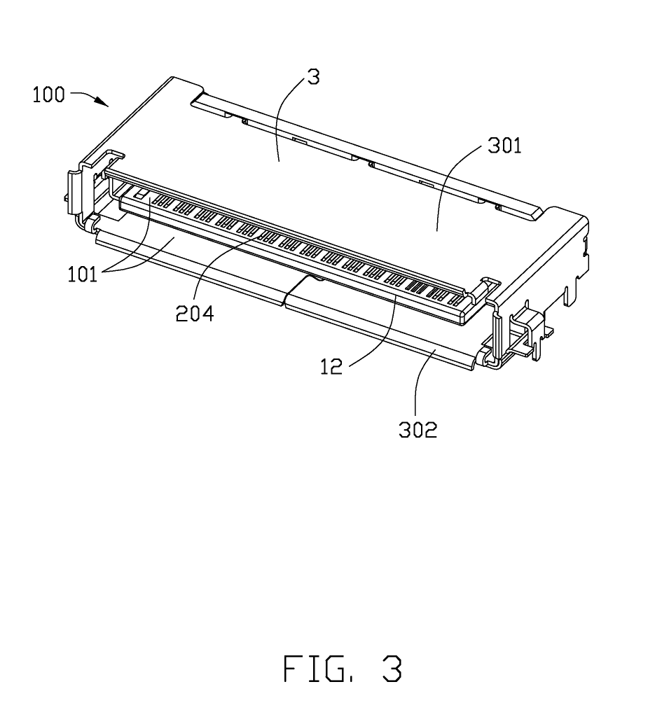

Referring to FIGS. 2, 3 and 4, the engaging portion 12 of the insulative housing 1 is a tongue shape configuration and surrounded by the shell 3 thereby forming a mating space 101 for receiving and mating with a mating connector (not shown). The base portion 11 forms a receiving slot 110 for receiving the spacer 4 and a protecting portion 110a for preventing the spacer 4 from moving upwards. Each of the contact 2 are inserted into the insulative housing along the direction A and includes a retaining portion 201 retained in the base portion 11, said soldering portion 203 extending out of the base portion 11 from one end of the retaining portion 201 and a contacting portion 204 extended into the mating space 101 for electrically connecting with the mating connector.

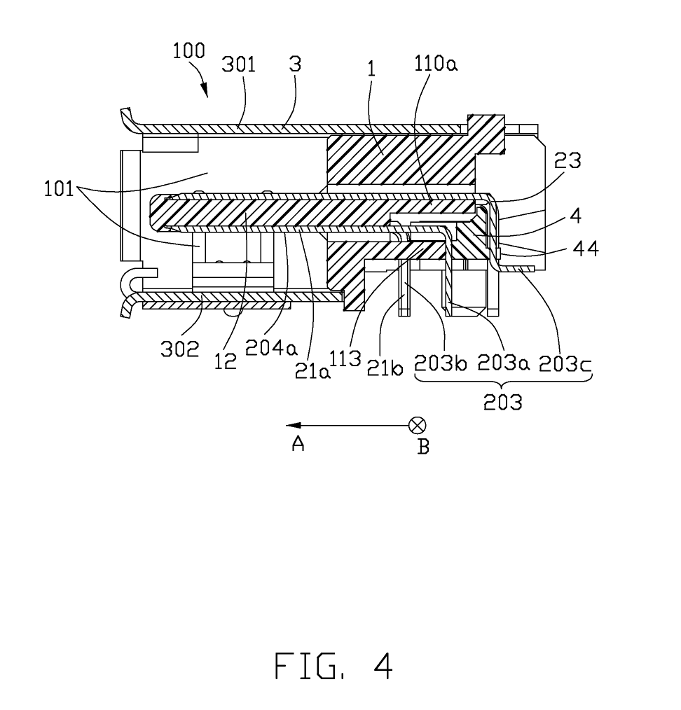

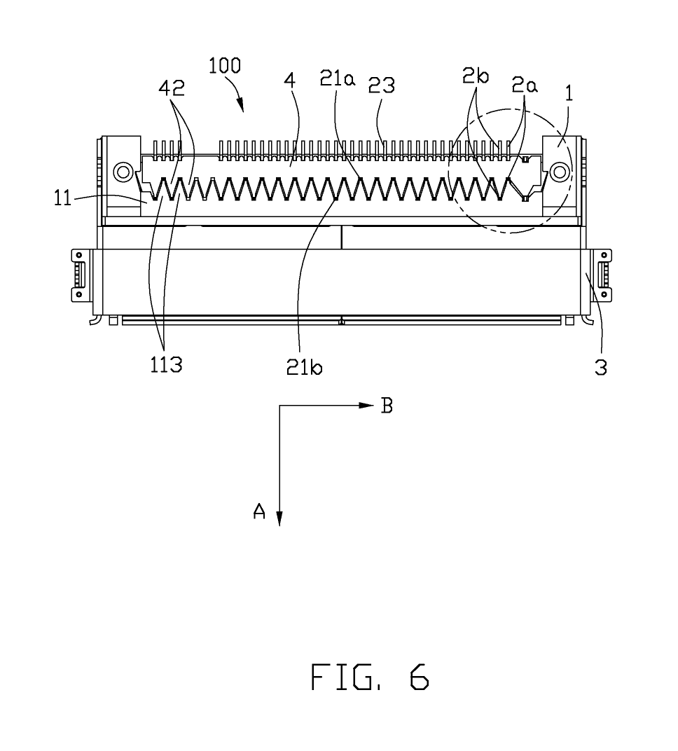

Referring to FIGS. 4, 5 and 6, the contacts 2 are respectively arranged in an upper side and a lower side of the engaging portion 12. Further more, a plurality of first contacts 21a and a plurality of second contacts 21b are located at the lower side of the engaging portion 12 and opposite to the bottom shell 302. A first contacting portion 204a of the first contact 21 and a second contacting portion 204b of the second contact 21b are coplanar, while the soldering portions 203a, 203b thereof are perpendicular to a mounting surface (not shown) of the electrical connector 100. While a plurality of third contact 23 are disposed on an upper side of the engaging portion 12 and opposite to the top shell 301. The soldering portions 203c of the third contacts 23 are arranged along the direction B in a row while the soldering portions 203 thereof are parallel to said mounting surface for soldered onto a corresponding PCB (not shown) as a surface mounting technology (SMT) manner.

Cooperation with FIGS. 2, 6 and 7, the base portion 11 defines a plurality of second wedged protruding portions 113 and a plurality of second wedged recessed portion 114 between the two adjacent second wedged protruding portions 113 along direction B thereby forms a second wedged positioning sections. The soldering portions 203a of the first contacts 21a are disposed and pre-positioned on a top of the second wedged protruding portions 113 and arranged in a row along the direction A. While the soldering portions 203b of the second contacts 21b are received and pre-positioned in the wedged recessed portion 114 and arranged in another row along the direction A. The soldering portions 203a, 203b are parallel to and alternated with each other, thereby forms a waved configuration.

The spacer 4 forms a plurality of first wedged protruding portions 42 and a first recessed portion 43 along direction B for respectively engaging with the second wedged recessed portion 114 and the second wedged protruding portions 113, thereby forms a first wedged positioning sections. The spacer 4 also includes a plurality of protruding portions 44 and a plurality of positioning grooves 45 formed therebetween at a rear side of the spacer 4 opposite to the first wedged positioning sections 42 thereof. The base portion 11 of the insulative housing 1 has a pair of slots 111 for receiving a pair of fitting portions 41 defined by both ends of the spacer 4 and two guiding surfaces 112 formed at an opening of the slot 111 for guiding the spacer 4 inserted into the insulative housing 1.

The spacer 4 is inserted into the receiving slot 110 of the base portion 11 and then blocked in the slot 111 when the first contact 21a and the second contact 21b are assembled into the insulative housing 1. So the soldering portions 203a, 203b are respectively sandwiched between the first wedged positioning section 43, 42 of the spacer 4 and the second wedged positioning sections 113, 114 of the base portion 11. The distance between the first contact 21a and the second contact 21b is added for prevent the contacts 2 from cross-talk. The third contacts 23 are inserted into after the spacer 4 assembled onto the insulative housing 1. Therefore the soldering portions 203c of the third contacts 23 are positioned between of two adjacent protruding portions 44 and received in the positioning grooves 45 of the spacer 4. As a result, the soldering portions 203 of the contacts 2 are divided into pre-mentioned three rows and then it is benefit for increasing a length of the electrical connector 100 in the direction B.

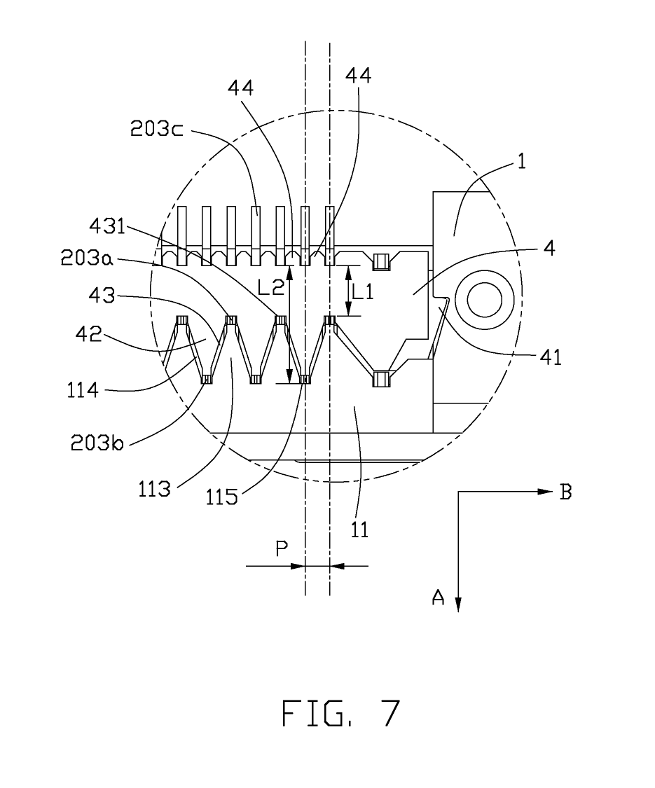

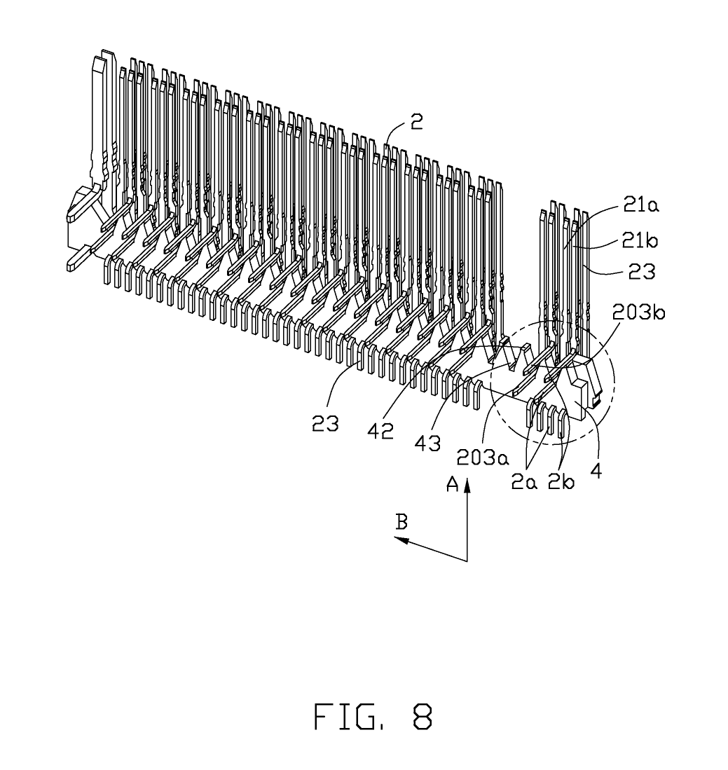

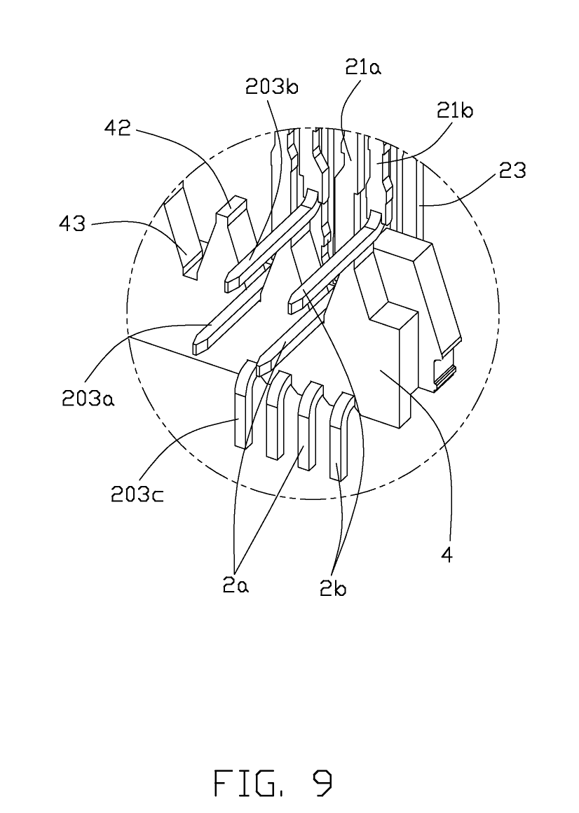

Referring to FIGS. 7, 8 and 9, the first contact 21a and the third contact 23 in alignment with each other in the direction A can be regarded as a first contact unit 2a, while the second contact 21b and the third contact 23 in alignment with each other in the direction A can be regarded as a second contact unit 2b. The first contact units 2a and the second contact units 2b are alternately arranged in an interval P along Direction B. A distance L1 between of the two soldering portions 203a, 203c is smaller than a distance L2 between of the two soldering portions 203b, 203c in the direction A, i.e. the soldering portion 203a of the first contact 21a is closer to the soldering portion 203c of the third contact 23 than the soldering portion 203b of the second contact 21b. In this structure, it is benefit for preventing the contacts 2 from cross-talk and reducing the size of the electrical connector 100.

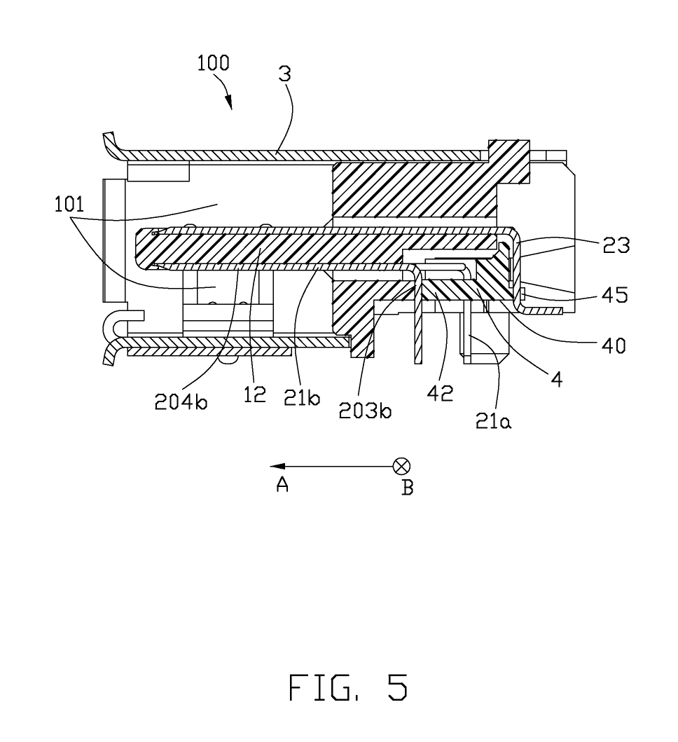

The spacer 4 defines an inner positioning area which is formed by the plurality of wedged positioning sections 42, 43 for cooperation with the base portion 11 of the insulative housing 10, and an external positioning area defined by the positioning grooves 45 at external side thereof, thereby the spacer 4 forms a positioning device for receiving and retaining the soldering portions 203 of the contacts 2. So the first contacts 21a and the second contacts 21b are positioned at the inner side of the spacer 4. The third contacts 23 are positioned at the external side of the spacer 4 as of the limited of the soldering portion 203c. The spacer 4 has a bottom side 40 parallel to the pre-mentioned mounting surface and the positioning grooves 45 thereof are perpendicular to and closed to the bottom side 40 for steadily fixing a footer of the soldering portion 203 of the third contact 23 (see FIG. 5). The base portion 11 forms a receiving recess 115 in bottom of the second recessed portion 114 for pre-position of and receiving the second contact 21b. The spacer 4 defines another receiving recess 431 similar to said receiving recess 115 and formed in the first recessed portion 43 for receiving and positioning the first contact 21a.

It is noted that the compliant engagement between the first wedged positioning sections 42/43 and the second wedged positioning sections 113/114 essentially requires a relatively large pitch between the neighboring soldering portions 203a, 203b. Therefore, the contacts 2 define the contacting portions 204a, 204b with the relatively small pitch in comparison with the soldering portions. If there is no increase of the pitch arrangement on the soldering portions 203a, 203b, the first wedged positioning sections 42/43 and the second wedged positioning sections 113/114 may be formed relative tiny with less strength thereof with inoperability issue. In fact, as disclosed in U.S. Pat. No. 7,537,465, the structure of the first wedged positioning sections and of the second wedged positioning sections is previously used with the contacts having two rows of contacting portions and two rows of soldering portions rather than one row of contacting portions and two rows of soldering portions. By means of the arrangement disposed in the invention, more flexibility and variety of the arrangement of the contacting portions and the soldering portions of the contacts may be obtained.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector comprising:
an insulative housing comprising a rear portion and a front portion along a first direction;
a spacer assembled on the rear portion of the insulative housing and comprising a plurality of first wedged positioning sections in an inner side thereof and arranged along a second direction perpendicular to the first direction;
a plurality of contacts received in the insulative housing and comprising a soldering portion extending out of the insulative housing;
wherein the spacer comprises a plurality of positioning grooves in an external side thereof for receiving and positioning the soldering portions of one part contacts located at an upper side of the front portion, and the soldering portions of the other contacts disposed at a lower side of the front portion are sandwiched between the first wedged positioning sections of spacer and a second wedged positioning sections of the rear portion thereby forming a waved configuration.

2. The electrical connector as described in claim 1, wherein the contacts disposed at lower side of the front portion comprises another soldering portion perpendicular to a mounting surface of the electrical connector.

3. The electrical connector as described in claim 2, wherein the contacts located an upper side of the front portion comprises a soldering portion parallel to a mounting surface of the electrical connector.

4. The electrical connector as described in claim 3, wherein the soldering portions of the contacts located at an upper side of the front portion are arranged in a row along the second direction and parallel to each other.

5. The electrical connector as described in claim 4, wherein the spacer comprises a bottom side parallel and the positioning grooves thereof are perpendicular to and closed to bottom side of the spacer.

6. The electrical connector as described in claim 2, wherein the soldering portions of the contacts disposed at a lower side of the front portion are arranged in two rows along the second direction which are parallel to each other.

7. An interconnection system with a positioning spacer comprising:
an insulative housing comprising a base portion and an engaging portion extending from the base portion along a first direction;
a plurality of first contact units and a plurality of second contact units alternately arranged in a predetermine interval along a second direction perpendicular to the first direction, each of said contact units comprising a pair of contacts, and each contact comprising a soldering portion;
the positioning spacer assembled with the base portion of the insulative housing and pressed against the first contact units and second contact units;
a first distance between of two soldering portions of each first contact unit is smaller than a second distance between of two soldering portions of each second contact unit in the first direction.

8. The interconnection system with a positioning spacer as described in claim 7, wherein the positioning spacer comprises an inner positioning area which is formed by a plurality of wedged positioning sections for cooperation with the base portion and an external positioning area is formed by a plurality of positioning grooves at an external side thereof.

9. The interconnection system with a positioning spacer as described in claim 8, wherein the first contact unit comprises a first contact disposed at a lower side of the engaging portion and a third contact disposed at an upper side of the engaging portion.

10. The interconnection system with a positioning spacer as described in claim 9, wherein the second contact unit comprises a second contact disposed at a lower side of the engaging portion and a third contact disposed at an upper side of the engaging portion.

11. The interconnection system with a positioning spacer as described in claim 10, wherein the soldering portions of the third contacts are arranged in a row along the second direction.

12. The interconnection system with a positioning spacer as described in claim 10, wherein the soldering portions of the first contact and the second contacts from a waved configuration along the second direction.

13. An interconnection system comprising:
an insulative hosing defining thereof a rear portion and a front portion along a first direction;
a plurality of first contacts disposed in the housing, each of said first contacts defining a mating portion extending into the front portion of the housing and a soldering portion extending out of the rear portion of the housing under condition that the mating sections are arranged in one row while the soldering portions are arranged alternately in two rows; and
a spacer assembled unto the rear portion of the housing and including a plurality of first wedged positioning sections located on a front side thereof along a second direction perpendicular to said first direction; wherein
said first wedges positioning sections commonly define a series of peak-valley structures along the second direction with equal intervals thereof so as to confront the alternately arranged soldering portions with a first pitch thereof in said second direction, while the mating portions are arranged with a plurality of groups and each group defines a second pitch smaller than the first pitch in said second direction.

14. The interconnection system as claimed in claim 13, further including a plurality of second contacts having corresponding contacting sections in another row parallel to the mating portions of the first contacts and having corresponding soldering sections behind the soldering portions of the first contacts, wherein a plurality of grooves are formed in the rear side of the space to respectively receive said soldering sections of the second contacts.

15. The interconnection system as claimed in claim 14, wherein said soldering sections are arranged in one row and said grooves are arranged in one row corresponding.

16. The interconnection system as claimed in claim 15, wherein said soldering sections include horizontal sections for surface mounting to a printed circuit board.

17. The interconnection system as claimed in claim 16, wherein said soldering portions of the first contacts define vertical sections for extending through the printed circuit board.

18. The interconnection system as claimed in claim 17, wherein the rear portion of the housing defines a plurality of second wedged positioning sections compliantly matching said plurality of first wedged positioning sections, respectively.

19. The interconnection system as claimed in claim 18, wherein there are three first contacts in each group, and each of said three first contacts has respective retention structure different from that of others.

20. The interconnection system as claimed in claim 19, wherein said three first contacts includes two side ones and a middle one under condition that each of said two side ones defines the retention structure on an outer side while the middle one defines the retention structure on both sides.
